(19) United States
(12) Patent Application Publication
(10) Pub. No.: US 2012/0075467 A1
(43) Pub. Date: Mar. 29, 2012

(54) IMAGE CAPTURE DEVICE AND METHOD FOR TRACKING MOVING OBJECT USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/969,423

(22) Filed: Dec. 15, 2010

(30) Foreign Application Priority Data
Sep. 29, 2010 (TW) 99132939

(51) Int. Cl. G06K 9/00; H04N 7/18

(52) U.S. Cl. 348/143; 382/103; 348/E07.085

(57) ABSTRACT

A method for tracking a moving object using an image capture device captures a plurality of images of a monitored scene using a lens module of the image capture device, and detects a moving object in the monitored scene from the captured images. The method further determines movement data of the image capture device according to movement data of the moving object, and controls the image capture device to move along a rail system to track the moving object according to the movement data of the image capture device.

### BACKGROUND

1. Technical Field

Embodiments of the present disclosure relate to security surveillance technology, and particularly to an image capture device and method for tracking a moving object using the image capture device.

2. Description of Related Art

Image capture devices installed on a rail system have been used to perform security surveillance by capturing images of monitored scenes, and sending the captured images to a monitor computer. However, a position of the image capture device in the rail system cannot be adjusted according to movement of an object in the monitored scene. Therefore, an efficient method for tracking a moving object using the image capture device is desired.

### BRIEF DESCRIPTION OF THE DRAWINGS

FIG. 1 is a block diagram of one embodiment of an image capture device.

FIG. 2 is a schematic diagram of the image capture device installed on a rail system.

FIG. 3 is a flowchart of one embodiment of a method for tracking a moving object using the image capture device.

FIGS. 4A-4C are schematic diagrams of one embodiment of controlling movement of the image capture device along the rail system to track the moving object.

FIGS. 5A-5B are schematic diagrams of one embodiment of adjusting a lens module of the image capture device.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

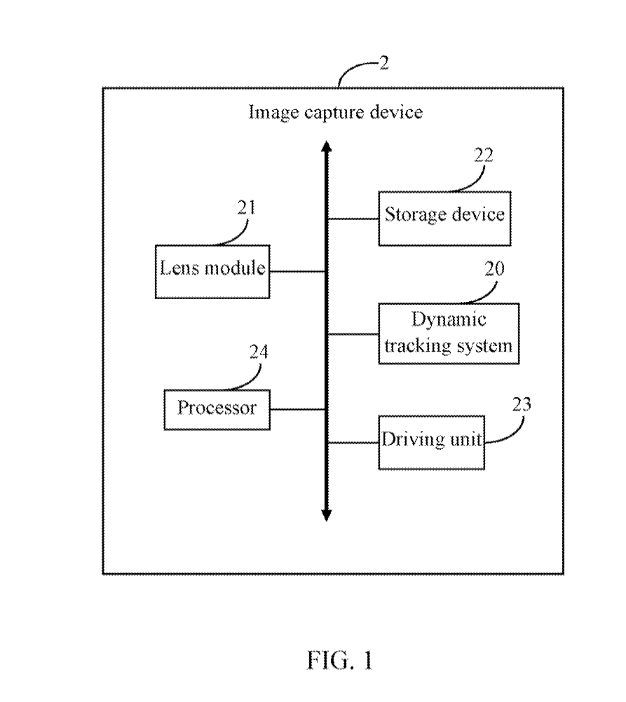

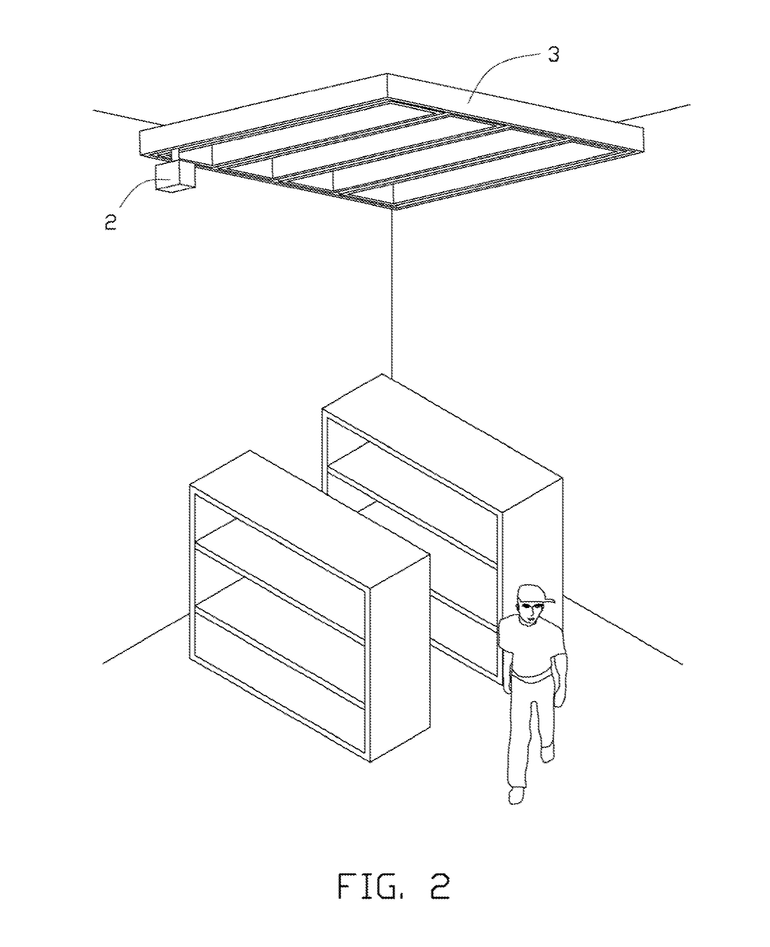

FIG. 1 is a block diagram of one embodiment of an image capture device 2. In one embodiment, the image capture device 2 includes a dynamic tracking system 20, a lens module 21, a storage device 22, a driving unit 23, and at least one processor 24. Referring to FIG. 2, the image capture device 2 is installed on a rail system 3. The rail system 3 comprises one or more tracks that the dynamic tracking system 20 may be used to control the image capture device 2 by moving along the tracks of the rail system 3 when a moving object is detected in a monitored scene. A detailed description will be given in the following paragraphs.

In one embodiment, the image capture device 2 may be a speed dome camera or a pan/tilt/zoom (PTZ) camera, for example. The rail system 3 may be installed on the top of the monitored scene or other suitable locations.

The lens module 21 captures a plurality of images of the monitored scene.

In one embodiment, the lens module 21 may include a charge coupled device (CCD) as well as lenses. The monitored scene may be the interior of a warehouse or other important place. The driving unit 23 may be used to drive the image capture device 2 moving along the rail system 3. In one embodiment, the driving unit 23 may be one or more driving motors.

In one embodiment, the dynamic tracking system 20 may include one or more modules. The one or more modules may comprise computerized code in the form of one or more programs that are stored in the storage device 22 (or memory). The computerized code includes instructions that are executed by the at least one processor 24 to provide functions for the one or more modules.

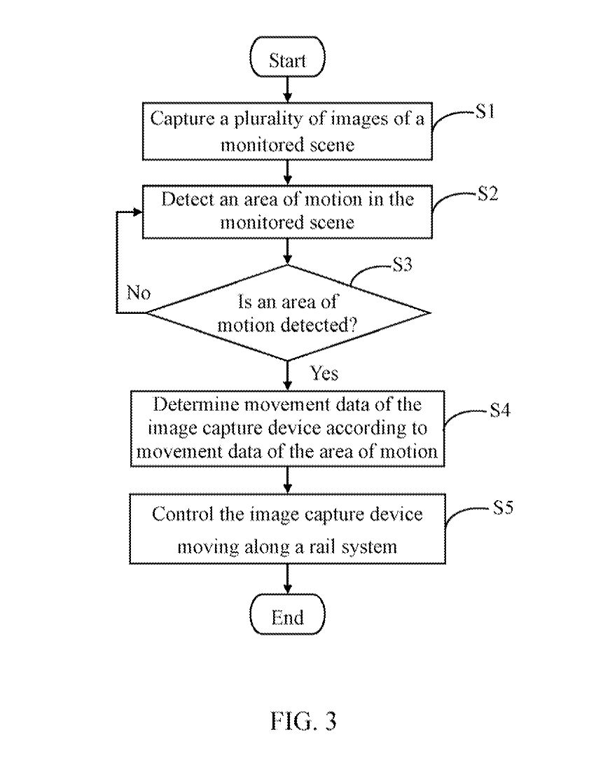

FIG. 3 is a flowchart of one embodiment of a method for tracking a moving object using the image capture device 2. Depending on the embodiment, additional blocks may be added, others removed, and the ordering of the blocks may be changed.

In block S1, the lens module 21 captures a plurality of images of a monitored scene. In one embodiment, the lens module 21 captures an images of the monitored scene after a preset time interval (e.g., five seconds).

In block S2, the dynamic tracking system 20 detects an area of motion in the monitored scene from the captured images. In one embodiment, the area of motion is regarded as an area of the monitored scene in which a moving object is detected. A detailed description is provided as follows.

First, the dynamic tracking system 20 obtains a first image of the monitored scene at a first time from the captured images, and calculates characteristic values (e.g., gray values of blue color) of the first image. Second, the dynamic tracking system 20 obtains a second image of the monitored scene at a second time continuous with the first time, and calculates the characteristic values of the second image. Third, the dynamic tracking system 20 compares the first image with the second image using autocorrelation of the characteristic values of the first image and the second image, and obtains a corresponding area in both of the first image and the second image. Fourth, the dynamic tracking system 20 compares the characteristic values of the corresponding area in both of the first image and the second image, and obtains an area of motion in the monitored scene if motion has occurred, according to differences in the characteristic values of the corresponding area in the first image and the second image.

In block S3, the dynamic tracking system 20 determines if an area of motion is detected in the monitored scene. If the area of motion is detected in the monitored scene, the procedure goes to block S4. If the area of motion is not detected in the monitored scene, the procedure returns to block S2.

In block S4, the dynamic tracking system 20 determines movement data of the image capture device 2 according to movement data of the area of motion. In one embodiment, the movement data of the image capture device 2 may include, but is not limited to, a direction of movement and a distance of movement. For example, the dynamic tracking system 20 determines that the image capture device 2 should move towards the left if the direction of movement in the area of motion is to the left, or determines that the image capture device 2 should be moved towards the right if the direction of movement in the area of motion is to the right.

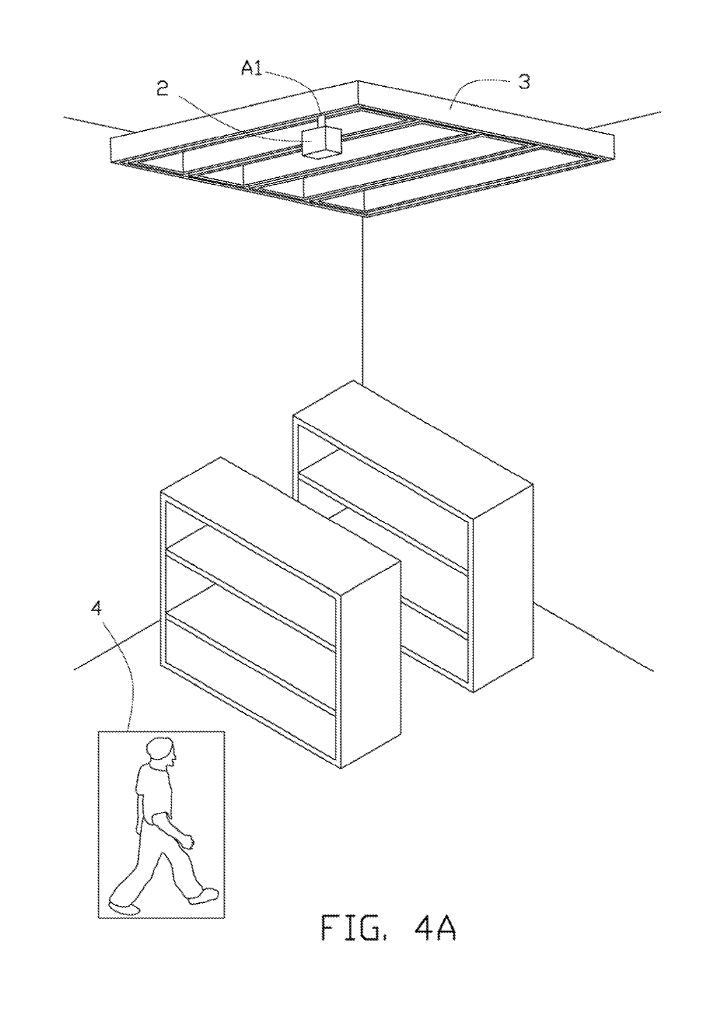

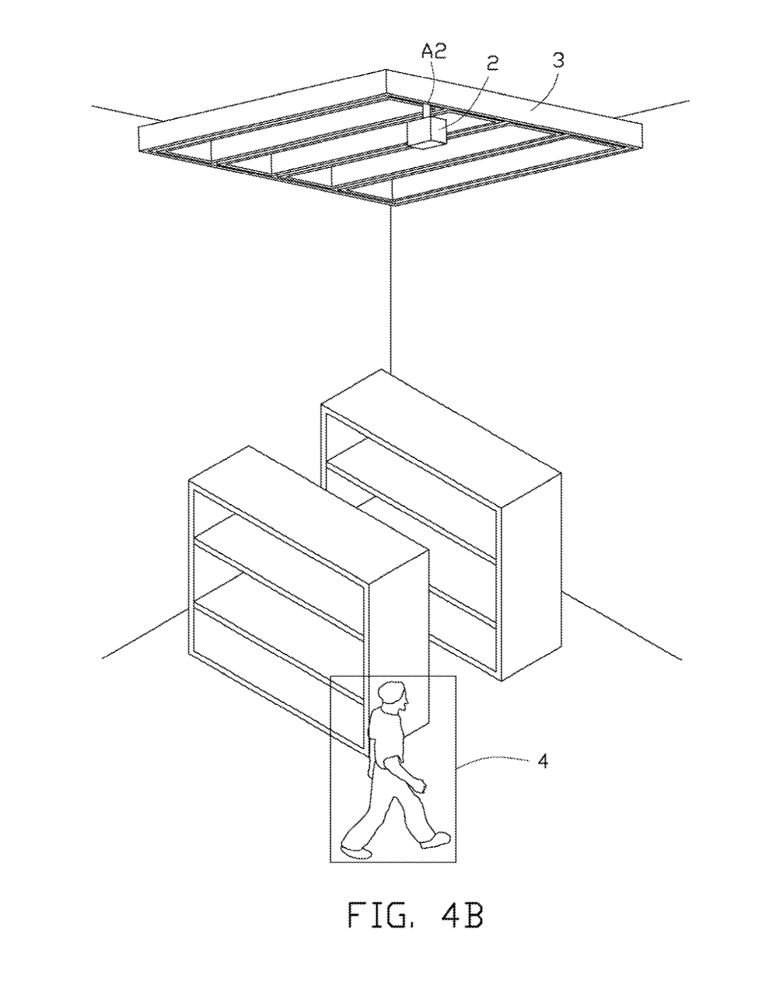

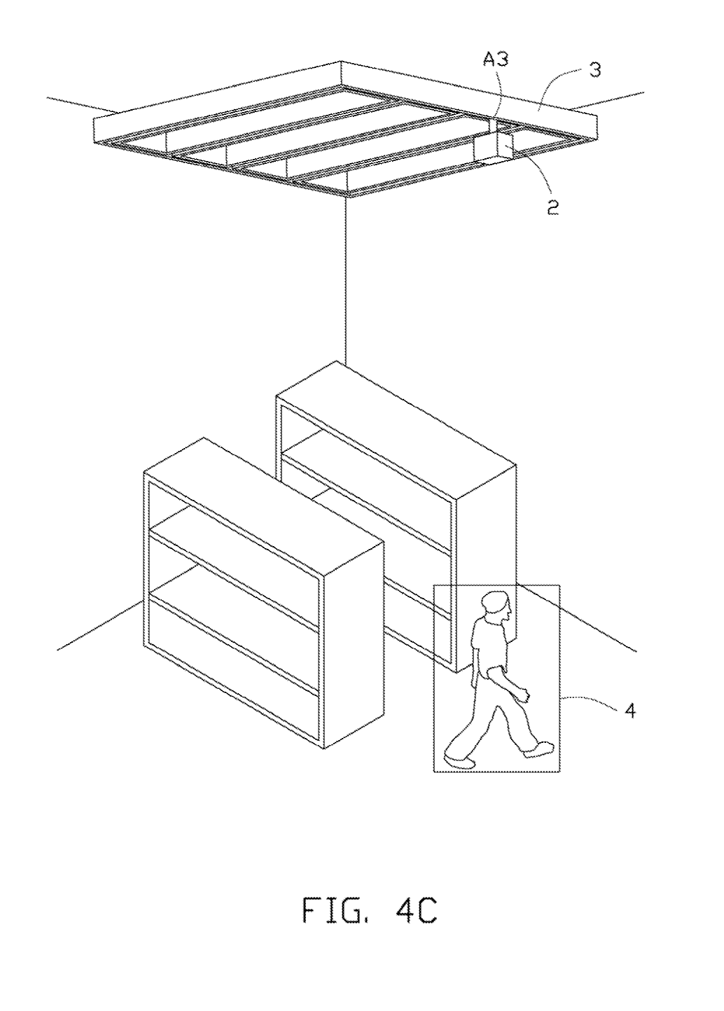

In block S5, the dynamic tracking system 20 controls the image capture device 2 to move along the rail system 3 to track the moving object according to the movement data of the image capture device 2. Referring to FIGS. 4A-4C, the image capture device 2 moves from a first position “A1” to a second position “A2” along the rail system 3 when a moving object 4 moves toward the right. The image capture device 2 further moves from the second position “A2” to a third position “A3” along the rail system 3 when the moving object 4 further moves right.

In other embodiments, if a ratio of a smallest rectangle enclosing the area of motion in a captured image is less than a preset value (e.g., 20%), the dynamic tracking system 20 sends a first control command to pan and/or tilt the lens module 21 of the image capture device 2 until a center of the smallest rectangle enclosing the area of motion is coincident with a center of the captured image. The dynamic tracking system 20 further sends a second control command to zoom in the lens module 21 of the image capture device 2 until the ratio of the smallest rectangle enclosing the area of motion in the captured image is equal to the preset value, to obtain a zoomed image of the moving object.

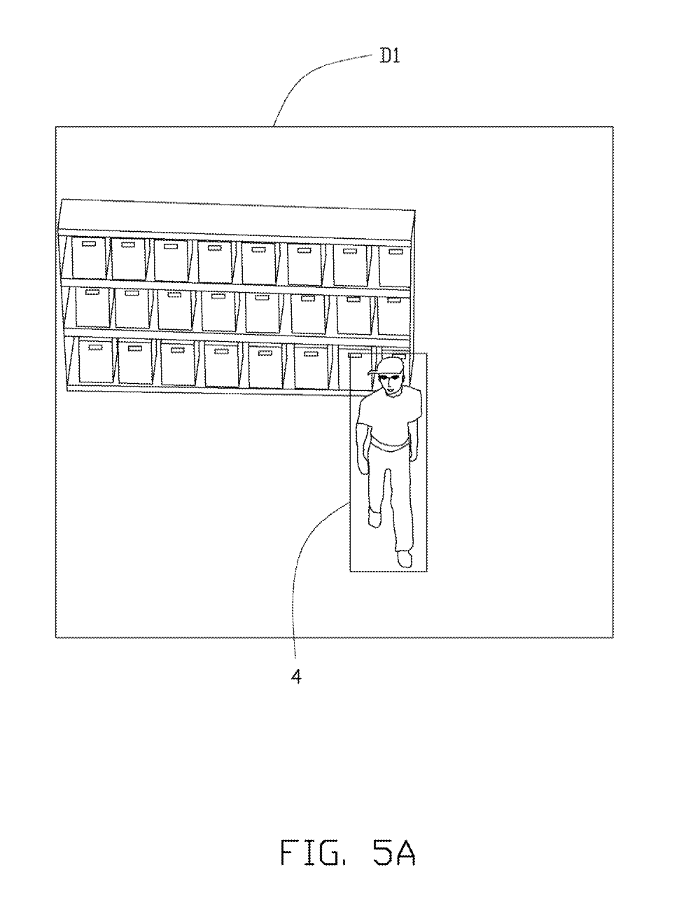

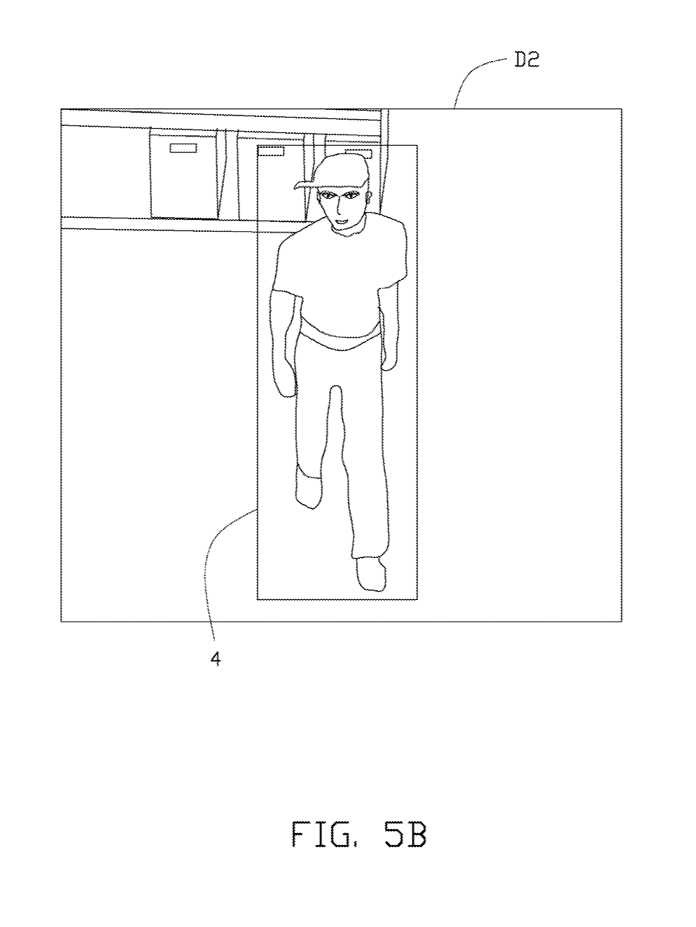

Referring to FIGS. 5A-5B, “D1” represents an image of the monitored scene captured by the lens module 21 when a moving object 4 is detected from the captured images. “D2” represents an image of the monitored scene captured by the lens module 21 when the lens module 21 is adjusted according to the movement data of the moving object 4.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for tracking a moving object using an image capture device, the image capture device being installed on a rail system, the method comprising:
capturing a plurality of images of a monitored scene using a lens module of the image capture device;
detecting an area of motion in the monitored scene from the captured images, the area of motion being regarded as a moving object;
determining movement data of the image capture device according to movement data of the area of motion; and
controlling the image capture device moving along the rail system to track the moving object according to the movement data of the image capture device.

2. The method according to claim 1, wherein the step of detecting an area of motion in the monitored scene from the captured images comprises:
obtaining a first image of the monitored scene at a first time from the captured images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

3. The method according to claim 1, wherein the movement data of the image capture device comprises a direction of movement and a distance of movement.

4. The method according to claim 1, further comprising:
sending a first control command to pan and/or tilt the lens module of the image capture device until a center of a smallest rectangle enclosing the area of motion is coincident with a center of a captured image upon the condition that a ratio of the smallest rectangle enclosing the area of motion in the captured image is less than a preset value; and
sending a second control command to zoom in the lens module of the image capture device until the ratio of the smallest rectangle enclosing the area of motion in the captured image is equal to the preset value.

5. The method according to claim 1, wherein the lens module of the image capture device includes a charge coupled device.

6. An image capture device installed on a rail system, comprising:
a lens module;
a storage device;
at least one processor; and
one or more modules that are stored in the storage device and are executed by the at least one processor, the one or more modules comprising instructions:
to capture a plurality of images of a monitored scene using a lens module of the image capture device;
to detect an area of motion in the monitored scene from the captured images, the area of motion being regarded as a moving object;
to determine movement data of the image capture device according to movement data of the area of motion; and
to control the image capture device moving along the rail system to track the moving object according to the movement data of the image capture device.

7. The image capture device according to claim 6, wherein the instruction to detect an area of motion in the monitored scene from the captured images comprises:
obtaining a first image of the monitored scene at a first time from the captured images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

8. The image capture device according to claim 6, wherein the movement data of the image capture device comprises a direction of movement and a distance of movement.

9. The image capture device according to claim 6, wherein the one or more modules further comprise instructions:
sending a first control command to pan and/or tilt the lens module of the image capture device until a center of a smallest rectangle enclosing the area of motion is coincident with a center of a captured image upon the condition that a ratio of the smallest rectangle enclosing the area of motion in the captured image is less than a preset value; and
sending a second control command to zoom in the lens module of the image capture device until the ratio of the smallest rectangle enclosing the area of motion in the captured image is equal to the preset value.

10. The image capture device according to claim 6, wherein the lens module of the image capture device includes a charge coupled device.

11. A non-transitory storage medium having stored thereon instructions that, when executed by a processor of an image capture device, causes the processor to perform a method for tracking a moving object using the image capture device, the image capture device being installed on a rail system, the method comprising:
capturing a plurality of images of a monitored scene using a lens module of the image capture device;
detecting an area of motion in the monitored scene from the captured images, the area of motion being regarded as a moving object;
determining movement data of the image capture device according to movement data of the area of motion; and
controlling the image capture device moving along the rail system to track the moving object according to the movement data of the image capture device.

12. The non-transitory storage medium according to claim 11, wherein the step of detecting the area of motion in the monitored scene from the captured images comprises:
obtaining a first image of the monitored scene at a first time from the captured images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

13. The non-transitory storage medium according to claim 11, wherein the movement data of the image capture device comprises a direction of movement and a distance of movement.

14. The non-transitory storage medium according to claim 11, wherein the method further comprises:
sending a first control command to pan and/or tilt the lens module of the image capture device until a center of a smallest rectangle enclosing the area of motion is coincident with a center of a captured image upon the condition that a ratio of the smallest rectangle enclosing the area of motion in the captured image is less than a preset value; and
sending a second control command to zoom in the lens module of the image capture device until the ratio of the smallest rectangle enclosing the area of motion in the captured image is equal to the preset value.

15. The non-transitory storage medium according to claim 11, wherein the lens module of the image capture device includes a charge coupled device.

16. The non-transitory storage medium according to claim 11, wherein the medium is selected from the group consisting of a hard disk drive, a compact disc, a digital video disc, and a tape drive.
